(19) United States
(12) Patent Application Publication
(10) Pub. No.: US 2026/0360149 A1
(43) Pub. Date: Nov. 12, 2026

(54) HYBRID SECURITY SYSTEM FOR ADAPTIVE ARTIFICAL INTELLIGENCE/MACHINE LEARNING-ENABLED DETECTION OF MARITIME PESTS

(71) Applicant: Contineo Marine Robotics, LLC, Centreville, MD (US)

(72) Inventors: Stuart D. Harshbarger, Centreville, MD (US); John Bartusek, Silver Spring, MD (US); Matthew V. Kozlowski, Halethorpe, MD (US)

(73) Assignee: Contineo Marine Robotics, LLC, Centreville, MD (US)

(21) Appl. No.: 19/120,873

(22) PCT Filed: Oct. 12, 2023
(86) PCT No.: PCT/US2023/076712

§ 371 Date: Apr. 14, 2025

Related U.S. Application Data
(60) Provisional application No. 63/379,237, filed on Oct. 12, 2022.

(51) Int. Cl. G06V 20/52; G06V 10/30; G06V 10/764; G06V 20/05

(52) U.S. Cl. CPC G06V 20/52; G06V 10/30; G06V 10/764; G06V 20/05

(57) ABSTRACT

A system for detecting a maritime concern, the system including a plurality of sensors configured to collect sensor data, one or more processor configured to detect a change occurring in a foreground features over background changes in the sensor data, a plurality of deterrent methods configured to deter the maritime concern, where the one or more computing devices are further configured to execute steps including filter out background motion artifacts associated with maritime environments, detect a maritime concern based on the sensed data with the at least one detection algorithm, classify the maritime concern based on the sensor data, and activate at least one deterrent method of the plurality of deterrent methods to deter the maritime concern based on its classification.

### CROSS-REFERENCE TO RELATED APPLICATION

This application claims the benefit of U.S. Provisional App. No. 63/379,237, filed Oct. 12, 2022, the entire disclosure of which is hereby incorporated by reference.

### BACKGROUND

Maritime concerns encompass a spectrum of potential physical safety, health safety, security and situational awareness to watercraft, their owners, guests, and crew. Collisions at sea, whether they involve other watercraft, navigational markers, floating debris, marine mammals, large fish, or other items pose a physical risk of harm to the vessel and its occupants, as well as the subject of impact. Further, maritime pests and nuisances such as birds and rodents pose significant health concerns to crew and pose risk of damage to rigging, sails, canvas or critical sensors and systems that are collectively far more significant than the cosmetic concerns and mess attributable to droppings, and related debris that may accrue during periods while a vessel is left unattended. In the case of maritime bird mitigation, conventional deterrent methods typically involve use of a generic artificial predator figure (such as an owl or hawk), wind activated motion elements, or wire attachments to reduce landing and congregation space. Not only are these methods largely ineffective, but they are also not tailored to a specific species and have no provisions for active mitigation should the bird or other pest land or board regardless of the deterrent method. In the broader case of marine mammal intrusion, human approach, and trespass, and so on, camera systems and alarms can at best notify the owner or crew that something or someone has been on board their vessel in their absence, serving mostly to raise attention for inspection of damage or possible theft upon their return. Conversely monitoring of crew, invited guests or other expected on-board persons for state of motion, falls, or potential overboard events may increase safety and security of the vessel and persons aboard.

It is apparent that a method and system for improved detection, classification, and characterization of the on-board persons and/or particular nuisance or threat is needed, and that active deterrent measures, mitigation measures, or one or more safety and/or security responses may be applied to improve safety and security of the vessel and crew. With improved awareness and characterization of the concern, appropriate deterrent methods, mitigation methods, and/or safety/security responses may then be selectively activated to ensure the most effective response of the particular species of nuisance, threat, or safety/security concern.

Further, it is well established that bird and animal pests, as well as their human counterparts will acclimate to certain perceived threats or by extension to the proposed deterrent methods and will modify their behavior as fear is reduced over time and exposure.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a system for detecting a maritime concern, the system including a plurality of sensors configured to collect sensor data, at least one detection algorithm configured to detect a change occurring in a foreground over broader background change measurements in the sensor data, a plurality of deterrent methods configured to deter the maritime concern, and a one or more computing devices, where the one or more computing devices is configured to filter out background motion artifacts associated with maritime environments, detect a maritime concern based on the sensed data with the at least one detection algorithm. classify the maritime concern based on the sensor data, and activate at least one deterrent method of the plurality of deterrent methods to deter the maritime concern based on its classification, is disclosed.

To address this changing behavior, this technology builds upon it baseline mapping of deterrent and mitigation techniques for corresponding nuisance and threats by learning whether an active deterrent or mitigation is effective for a particular concern and by adapting the response through alternative patterns, modalities, or combinations of selected active response methods. As new methods are observed to be more or less effective, the system will automatically record this change as positive or negative reinforcement and this observation will be used to improve system response in future occurrences through regularly occurring system updates to the Artificial Intelligence or Machine Learning (AI/ML) models and mitigation methods utilized.

In another aspect, a method of detecting a maritime concern with the system of the systems disclosed herein is disclosed.

It is an objective of this disclosure to describe a system of multi-modal distributed smart nodes that provide for local vessel safety and security while sharing information via a maritime community network (based on selectable user preferences) to enable improved system response for individual nuisance and threat concerns with consideration to regional and seasonal factors and adaptation.

This disclosure relates to a method and system for detecting and mitigating pests, hazards, or threats to marine vessels and crew either at the pier, underway or at anchor. Particularly, this disclosure relates to detection of birds, rodents, reptiles, marine mammals and humans that may pose a nuisance, health concern, or threat of damage, theft or harm when in close proximity to the vessel, in the process of landing upon or boarding the vessel, or already aboard or upon the vessel. Upon detection, the system may activate traditional alarms and alerts (locally or via wired or wireless communications methods), as well as active response deterrents and robotically actuated mitigations. More particularly, this disclosure relates to a method and system for applying Artificial Intelligence or Machine Learning (AI/ML) algorithms together with more traditional image or signal processing techniques to identify indicators of approach, landing, boarding or onboard presence through one or more smart sensors and to respond to such concerns with an active deterrent response specifically tailored to the nature of nuisance or threat detected (examples include light(s), sound(s), vibration patterns, robotic movements, controlled release of repellents, etc.), with provisions for active (non-lethal) mitigation response to interrupt the activity should initial mitigation methods not be sufficient. Specifically, this invention relates to a technique of fusing information from one or more smart sensors, enabled by novel adaptive AI/ML algorithms that utilize both static and temporal information through a hybrid implementation with traditional image and signal processing methods to achieve robust activity and scene-change detection in highly dynamic and high motion settings with the additional capability of recognizing and identifying the particular nuisance or threat (e.g. category/class/species) such that an appropriately matched and effective deterrent and/or mitigation method may be applied, or in the case where an endangered species may be present, appropriate restraint and measures be applied.

### DESCRIPTION OF THE DRAWINGS

A clear understanding of the key features of the invention summarized above may be had by reference to the appended diagrams, which illustrate the key underpinning sensors, signal processing blocks, system components, feedback paths, and user community networking to achieve the hybrid, multi-modal, self-adapting, and continuously learning methods and system of the invention, although it will be understood that such drawings depict preferred embodiments of the invention with example sensor, deterrent, and mitigation methods and, therefore, are not to be considered as limiting its scope with regard to other embodiments which the invention is capable of contemplating. Accordingly:

FIG. 1 is a simplified illustration of an example system, in accordance with the present technology;

FIG. 2 is a simplified illustration of another example system, in accordance with the present technology;

FIG. 3 is an illustration of the method and system of this invention showing a simplified block diagram and key subcomponents or algorithms for each of the functional blocks indicated in FIG. 2, in accordance with the present technology; and

FIG. 4 is a method of using the system, in accordance with the present technology.

### DETAILED DESCRIPTION

The method and the system of this disclosure center around the innovative concept of enabling appropriately matched active mitigation and deterrence methods for a variety of nuisance, pests or threats known to be of concern within the maritime environment (therefore, referred to herein individually or collectively, as the concern).

In some embodiments, the plurality of sensors and data sources includes visible wavelength, near-Infrared, or Thermal imaging camera(s), Light Detection and Ranging (LIDAR) sensors, inertial/accelerometer based sensors, acoustic sensor(s), Sound Navigation and Ranging (SONAR) sensors, Radio Detecting and Ranging (RADAR), Precise Navigation and Timing (PNT) system components and remote sensors from autonomous systems (e.g. drones); vessel navigation data including: vessel heading, relative wind direction, true wind direction, wind speed, vessel speed, Global Positioning System (GPS) location coordinates, time, and; local weather data including wind direction, wind speed, tidal currents, cloud cover, and precipitation.

In some embodiments, a plurality of sensors may be used to detect maritime concerns involving the threat of collision between the device-mounted vessel and other vessel(s) moving with converging paths, regardless of which vessel is underway. In such embodiments, the plurality of deterrent methods includes display warnings, lights, sounds, or radio transmissions to alert crew members attending either or both vessels. If no action is then taken by crew, mitigation methods may be initiated to include actuated or robotic controls to modify vessel propulsion state, steerage or autopilot settings as necessary to avoid a collision if possible. In such embodiment, AI/ML-based or other detection algorithms may be used to both detect and classify the type of converging vessel, and to thereby determine corresponding estimates of respective maneuvering capabilities, which may be combined with navigational data and sensor indications of relative course and speed to determine the specific mitigation parameters appropriate to the selected method.

In some embodiments, a plurality of sensors may be used to detect maritime concerns involving the threat of collision between the device-mounted vessel and either known or unknown objects or debris determined to be in the vessels path of motion. In such embodiment, the plurality of deterrent methods includes display warnings, lights, sounds, or radio transmissions to alert the crew and to signal warning in the event that the unknown object is capable of response. If no action is then taken by crew, mitigation methods may be actuated to include actuated or robotic control to modify vessel propulsion, steerage or autopilot settings as necessary to avoid the collision when possible. In such embodiment, AI/ML or other detection algorithms may be used to both detect and classify the specific nature of the collision concern where possible which may be combined with navigational data and sensor indications of relative course and speed to determine the specific mitigation parameters appropriate to the selected method.

In some embodiments, the plurality of deterrent or mitigation methods includes lights, sounds, vibrations, release of repellants, actuated or robotic movements (or robotic response via tethered, airborne or waterborne unmanned devices or autonomous systems (e.g. drones)) in various patterns or amplitudes, or a combination thereof.

In some embodiments, the one or more computing devices is further configured to, after activating the at least one deterrent method, detect whether the maritime concern is eliminated, and, when the maritime concern is not eliminated, store the at least one deterrent method with the classification of the maritime concerns as an unsuccessful deterrence, escalate deterrence by activating at least a second deterrent method of the plurality of deterrent methods, and, when the maritime concern is eliminated, store the at least one deterrent method with the classification of the maritime concern as a successful deterrence. In some embodiments, the one or more computing devices is further configured to store the successful deterrence or the unsuccessful deterrence with corresponding metadata comprising time, date, location, environmental conditions, or a combination thereof along with sensed data from the plurality of sensors, and when another maritime concern has the same classification as the successful deterrence is detected, activate the at least one deterrence of the successful deterrence, and when the another maritime concern has the same classification as the unsuccessful deterrence, activate another deterrence of the plurality of deterrence that is distinct from the at least one deterrence of the unsuccessful deterrence. In some embodiments, the one or more computing devices is further configured to share the successful deterrence or the unsuccessful deterrence with a community network to improve performance of the system.

In some embodiments, the system further includes a plurality of mitigation measures configured to disrupt the maritime concern, and the one or more computing devices is further configured to detect whether the maritime concern is eliminated by the at least second deterrent method, and, when the maritime concern has not been eliminated, activate at least one mitigation measure of the plurality of mitigation measures based on the classification of the maritime concern. Similarly, alerts and active response to crew falls or persons overboard may be initiated to include synchronization and fusion of multiple sensor inputs to validate the concern and to determine the precise nature, time and location of occurrence using metadata from detection sensors and from data provided either via the device or separately from vessel Global Positioning System (GPS) receivers, inertial sensors (accelerometers), magnetic-based or other vessel heading sensors, vessel speed indicators for determining and configuring mitigation measures and parameters such as settings for active motion-enabled camera tracking and to fuse information from wind speed indicators, weather data receivers, and other navigation system components, to initiative and optimize mitigation response such as the deployment of buoys, drones, or other automatic person overboard response technologies to the best estimate of the size and location of the anticipated search and rescue area.

In some embodiments, detection of the maritime concern comprises a classification of a specific species of the maritime concern. In some embodiments, the plurality of sensors is selected from cameras, video sensors, acoustic sensors, light detection and ranging (LIDAR) sensors, sound navigation and ranging (SONAR) sensors, near infrared sensors, thermal sensors, sensors from autonomous vehicles (for example aerial drones) and combinations thereof. In some embodiments, classification of the maritime concern comprises implementing at least an artificial intelligence (AI) algorithm, a machine learning (ML) algorithm, or a combination thereof.

The system applies a hybrid approach that combines motion compensation of the image/video sensors (e.g., relatively high frequency effects due to vibration, wind, mast and mounting hardware movement, etc.), together with statistically based characterization and suppression/subtraction of background motion artifacts associated with the maritime environments. The latter addresses background motion that may result from the motion of masts and neighboring boats when docked at a marina, or motion induced as a vessel at anchor or on a mooring swing around its anchor or mooring ball due to changing wind, waves or tides.

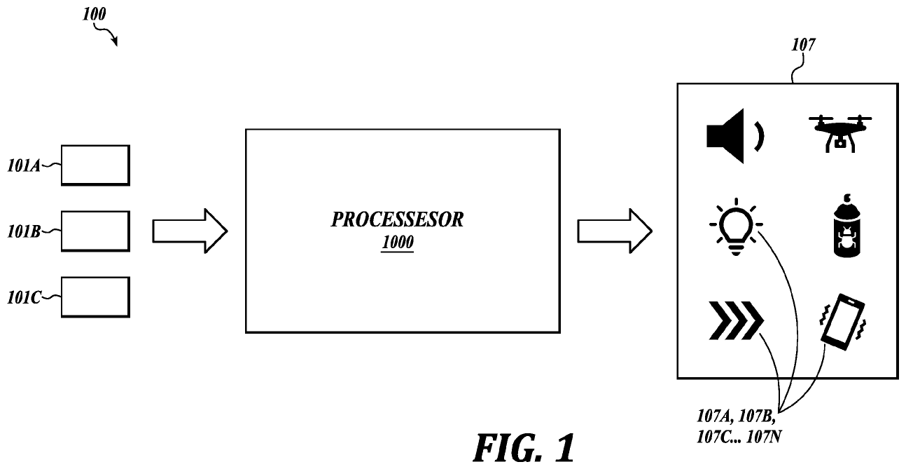

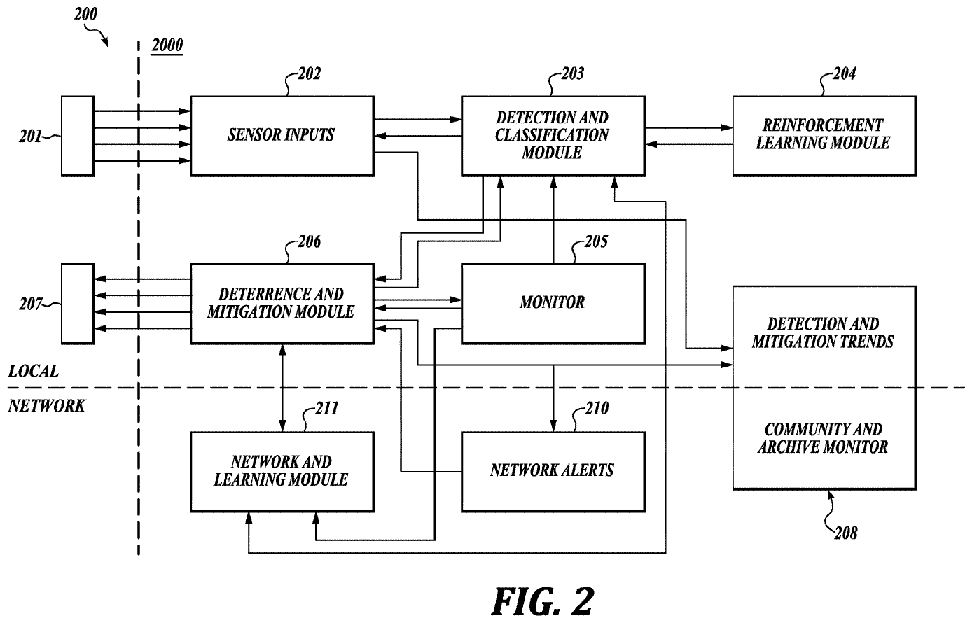

In some embodiments, the detection algorithm is a image or video based scene change algorithm. The application of background suppression/subtraction serves to improve the intended function of scene change detection algorithms by emphasizing change occurring in the foreground over broader background change measurements of the image as a whole. This in turn improves performance for detecting concerns in the foreground corresponding to image/video content concentrated on or near the vessel, its rigging, or its spreaders or spars. Background suppression/subtraction also serves to reduce image entropy and background “noise” for improved performance of the Artificial Intelligence/Machine Learning (AI/ML) algorithm(s) that are applied within this invention to not only detect the arrival or presence of a concern, but to also identify the nature of the concern, including identification of a concern as a member of a specific class (bird, marine mammal, rodent, snake, human, etc.) and (where sufficient training data exists) to classify the concern by not only its class, but also by its species. The ability to classify a concern to the level of species is further enhanced through multi-modal fusion as indicated in FIGS. 1 and 2. Where training data is available, image features from an individual scene or frame may provide identifying information, but moreover, temporal patterns, associated with movements such as hovering, landing, posing, walking, crawling, slithering, etc., may provide additional indications of species identity, or, in the case of human detection, circling by dinghy or other vessel, slowing alongside, or uninvited boarding/trespassing (as examples) may serve as indicators of human intent. The fusion of indications from static scenes or frames with temporal indicators from video segments may then be combined with additional modalities such as audible information or vibration patterns where identifiable acoustic/sound patterns such as bird song or calls are discernible, or where non-environmentally induced vibration patterns from identifiable behaviors/movements may be recorded.

Once a particular concern is detected and, as possible, identified, a specifically tailored (or otherwise general) deterrent method may be activated as indicated for illustrative purposes only by Table 1.

TABLE 1

| | | | | Local | Aggregated | Location & | |
|---|---|---|---|---|---|---|---|
| Bird | Primary | Deterrent | Activation | Effectiveness | Effectiveness | Effectiveness | Protective |
| Species | Range | Method | Parameters | Scores | Score | Metadata | Measures |
| Herring | Northeastern | Horn | Amplitude; | HGL 1 | REGHGX1 | Location | UKN |
| Gull | US Coast | | Duration; | HGL 2 | | Date | |
| | | | Frequency | HGL 3 | | Time | |
| | | | Patterns | HGL AVG | | Results | |
| Roseate | Northeastern | Hawk | Hawk | RT 1 | REGRTX1 | Location | UKN |
| Tern | US Coast | Cry | Species | RT 2 | | Date | |
| | | | Pitch | RT 3 | | Time | |
| | | | Pattern | RT AVG | | Results | |
| | | | Amplitude | | | | |
| | | | Period | | | | |
| Pigeon | Broad | Vibro- | Waveform | CP 1 | REGCPX1 | Location | None |
| | Ranging | tactile | Pattern | CP 2 | | Date | |
| | | Activation | Amplitude | CP 3 | | Time | |
| | | | Repetition | CP AVG | | Result | |
| | | | Rate | | | | |
| | | | Period | | | | |
| | | | Frequency | | | | |
| Osprey | Mid- | Human | Annunciation | Separate and | REGOSX1 | Location | Nesting |
| | Atlantic | voice + | Amplitude | Combined | | Date | |
| | | Actuated | Pitch | Deterrent | | Time | |
| | | Motion | Repetition | Scores | | Result | |
| | | | Rate | | | | |

Table 1 shows example methods for active deterrence once a Nuisance, Pest, Safety/Security Concern or Threat (collectively, the concern) has been detected, in accordance with the present technology. Note, this Table serves only as an example for the bird class of concern, with only a few species and deterrence methods listed; while for the system described in this disclosure, there would be many more classes, species, concerns and deterrence methods defined and in use.

In Table 1, a list of deterrence methods is indicated along with modulation/activation parameters and escalation provisions. Local measures of effectiveness are self-derived through continuous monitoring. For example, if a deterrence method is activated during detection of a concern and the concern subsequently moves beyond the sensor range, then this deterrence method would be recorded as having a positive effect for this event. However, if the alert persists after the deterrence method is activated for an extended duration (programmable threshold) then the deterrence method may be observed to be ineffective and thus scored as such. The logic would indicate escalation to the next higher level of deterrence (method, amplitude, pattern, frequency, duration, etc.) and the resulting effectiveness would be recorded. If the increased level of deterrence activation is unsuccessful, then the cycle would repeat until elevation to mitigation measures may be required and the first-level mitigation measure be activated, with the effectiveness recorded, and so on. Note that Table 1 serves only as a small example for the bird class for illustrative purposes only and the full system extends to include many more classes of concern, species, and deterrence methods.

This deterrent method may involve a plurality of lights, sounds, vibrations, release of repellents, deployment of autonomous vehicles (for example, aerial drones), and/or actuated/robotic movements in various patterns and amplitudes as determined both appropriate for the particular concern and effective through prior learning at the local system level and potentially through aggregation and sharing of data from the Maritime Community Network (described below). Deterrence may involve escalation of amplitude, activation patterns, or strength, as well as, alternating or escalating deterrent methods for assured effective response while ensuring compliance with any statutory species protections and remaining consistent with observed best practices as appropriate.

Ideally, if the concern is detected early enough, deterrence methods may be applied to discourage and prevent landing or boarding of the vessel, however, the nomenclature where the window for active deterrence extends through detection of an onboard concern is used and through a series of escalating deterrent mitigations intended to minimize the dwell time of the concern. During active deterrence, modulation and activation parameters are recorded along with feedback of whether the deterrence method produced the desired result of the concern leaving the vessel proximity. If deterrence methods are determined successful through elimination of the detected alert, this information is stored as positive feedback and the local average or aggregate score for the corresponding deterrent method and activation parameters are recorded for the detected species and corresponding metadata related to time, date, location, and environmental conditions (where available) along with recorded sensor data from the event. Based on user preferences, this data may be shared with the community network and used as additional training data to improve performance of detection algorithms and deterrent methods across the community of users. Additionally, recorded sensor data may be used for subsequent forensic analysis of damage or theft should deterrence and mitigation measures ultimately not be effective. To address any possible privacy concerns regarding data collected by the system from owners of the data, the sharing of data would be optional and selectable through system configuration settings made by the data owner.

In the event that a concern persists beyond the initial window of deterrent activation, a second tier of active response measures may be applied. Logically, the mitigation measures are an extension of deterrent methods and are inherently supported by the invention. Mitigation measures are identified separately as they are intended to disrupt the activities, rest, or behaviors of the detected concern and may involve methods that are of increased awareness or disruption to neighboring vessels or surrounding wildlife or persons. Similar to deterrent methods, this invention notes a plurality of mitigation measures that range from increased electro-mechanical or robotic actuation/response to the use of autonomous vehicles (such as aerial drones) or the automated dispersion of aerosolized compounds that may be deemed as effective and appropriate measures for persistent concerns. Given the increased disruptive nature of mitigations and their potential to impact behavior patterns of wildlife and humans in near proximity, a designated human operator (vessel owner, crew member on watch, or security proxy as examples) may be contacted (when communications and urgently allow) for affirmation of mitigation response prior to action.

The Maritime Community Network provides for a shared community of users where enabling training data may be curated and labeled by members to improve recognition and identification of concerns that are not supported by baseline or subsequently deployed classification models. Shared sensor data for general detections where the specific concern or species was indeterminate by the local system may be shared for review and marking by community experts, thus contributing to improved training data for model updates back to the local subscriber members. To encourage community engagement and for continuous improvement of the invention's performance and utility, a Community Dashboard is envisioned to enable individual subscribers to monitor region wide deterrent performance data and gain insight to regional concerns, as well as, to gain insight to the variety of species that may be encountered in various regional maritime settings.

This disclosure describes a system of adaptive distributed multi-modal smart nodes that provide for local maritime safety and security while sharing information via a Maritime Community Network (based on selectable user preferences) to enable continuous learning and improved response for localized detection and mitigation of nuisance, pest and threat concerns within the maritime setting and beyond. Additionally, the disclosure describes a method for data aggregation and distributed learning within a hybrid implementation of Artificial Intelligence/Machine Learning (AI/ML) algorithms that provides for local AI/ML learning and hybrid self-adaptation, as well as regular re-training and distribution of models derived from aggregated system data with consideration to both regional and seasonal factors.

FIG. 1 is a simplified illustration of an example system 100, in accordance with the present technology. In some embodiments, the system 100 includes one or more sensors 101A, 101B, 101C, a processor (or computing device) 1000, and at least one deterrent 107.

In some embodiments, the one or more sensors 101A, 101B, 101C include one or more visual sensor, proximity sensor, positioning sensor (such as a global positioning sensor (GPS)), or the like. In some embodiments, the plurality of sensors may be installed or otherwise located in multiple locations of a boat or vessel, so as to collect data from multiple locations. In some embodiments, the one or more sensors 101A, 101B, 101C are real-time sensors. In operation, each sensor of the one or more sensors 101A, 101B, 101C are configured to capture data and transmit that data to the processor 1000.

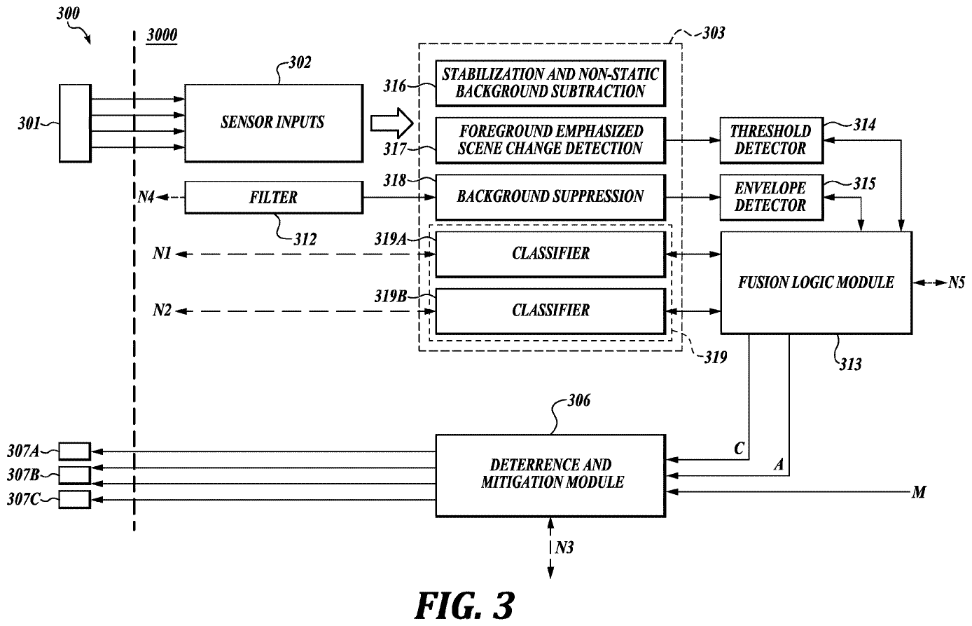

In some embodiments, the processor 1000 is a computing device. In some embodiments, the computing device includes a tangible machine and/or a computer readable storage medium. In some embodiments, the processor 1000 is a component of a computing device. In operation, the processor 1000 is configured to receive data from the one or more sensors 101A, 101B, 101C, and direct the deterrent 107. In some embodiments, the processor 1000 is configured to detect a maritime concern (such as a pest, a safety concern, a security concern, or the like), determine an appropriate deterrent 107, and activate that deterrent 107. In some embodiments, the processor 1000 makes its determination with an ML/AI algorithm, as shown and described in detail in FIGS. 2-3.

In some embodiments, the deterrent 107 includes a plurality of deterrents 107A, 107B, 107C. In some embodiments, the plurality of deterrents 107 includes noises, lights, deployment of a drone, an aerosol, movement, such as by actuated systems, and/or vibration. In some embodiments, a type of deterrent 107 activated by the processor 1000 is determined based on the processor's 1000 classification and/or identification of the maritime concern. In some embodiments, one or more deterrent of the plurality of deterrents 107A, 107B, 107C are a mitigation factor. As used herein, a mitigation factor is a mechanism for remedying or otherwise lessening the negative impact of a maritime concern.

For example, if the processor 1000 determined, from the one or more sensor 101A, 101B, 101C data, that someone had fallen overboard, the processor 1000 may activate release of a life preserver or flotation device as a mitigation factor.

FIG. 2 is a simplified illustration of another example system 200, in accordance with the present technology. In some embodiments, the system 200 is the system 100 of FIG. 1. In some embodiments, the system 200 includes a plurality of sensors 201, and a plurality of mitigation factors 207. In some embodiments, the system 200 includes a processor 2000, including one or more sensor inputs 202, a detection and classification module 203, a reinforcement learning model 204, a monitor 205, a deterrence and mitigation module 206, a trend module 208, one or more network alerts 210, and a network and learning module 211. As shown in FIG. 2, the dashed vertical line delineates the processor 2000. The dashed horizontal line delineates local (i.e., internal to the processor) activity and network (i.e., cloud) activity. As used herein, a module may be implemented as software logic (e.g., executable software code), firmware logic, hardware logic, or various combinations thereof. In some embodiments, signals from any of the modules discussed below may be transmitted to the processor 2000.

The plurality of sensors 201 provide data (or sensor inputs 202) from one or more sensing modalities that may involve, but are not limited to, video sensors (encompassing the visible spectrum, near infrared (NIR), or thermal (infrared)), acoustic sensors (audible or vibration), Light Detection and Ranging (LIDAR) sensors, and/or Sound Navigation and Ranging (SONAR) sensors depending on availability and nature of concern(s) anticipated. In some embodiments, each sensor of the plurality of sensors 201 provide a sensor input 202. In some embodiments, the plurality of sensors 201 may be vessel navigation components or systems located on a vessel. In some embodiments, the plurality of sensors 201 may include wind speed, wind direction, heading, vessel speed, navigation inputs, or the like. In some embodiments, the plurality of sensors 201 can include sensors for detecting local weather data and/or tide/tidal current data.

In some embodiments, the system further includes a detection and classification module 203. In some embodiments, the detection and classification module 203 is configured to detect and classify any number of maritime concerns, including nuisances, pests, threats, safety concerns, and the like. In some embodiments, the detection and classification module 203 detects and classifies the maritime concerns based on an ML/AI algorithm, as shown and described in detail in FIG. 3.

The system 200 may further include a reinforcement learning module 204 configured to provide local reinforcement learning and adaptation via cross-modal fusion and feedback. This may occur at various levels.

The system 200 may further have a trend module 208. In some embodiments, the trend module 208 is configured to detect trends locally (i.e., within the processor 2000 system) and at the community level (i.e., through a network). In some embodiments, the trend module 208 indicates provisions for both local and network (cloud) archival, as well as access a Community Dashboard that provides broad user insight to global detection/activation events while enabling aggregated learning and periodic model updates from community subscribers. In the case of unidentified concerns, video and other recorded sensor data may be archived for subsequent curation and for marking by approved members/experts as a means of enabling future AI/ML model improvements and improved tailored deterrence/mitigation methods and measures through sharing of model adaptation and learning from subscriber systems and via community enhanced training data.

In some embodiments, the monitor 205 is a command, direction, or input from an attendant or user of the system 200. In some embodiments, the monitor 205 directs the detection and classification module 203 and/or the deterrence and mitigation module 206 to activate. In some embodiments, the monitor 205 approves activation of a deterrent of the plurality of deterrents 207. In some embodiments, the monitor confirms or rejects a classification or detection from the detection and classification module 203.

In some embodiments, one or more network alerts 210 may further inform the deterrent or mitigation factor applied. For example, if the system 200 is successful in deterring a maritime pest, the system may issue a network alert 210 to assist other non-local systems in deterring the same pest. In another example, if another non-local system failed at mitigating a maritime threat, a network alert 210 could be issued to the system 200 to better inform its selected deterrence or mitigation for the same event.

In some embodiments, the network and learning module 211 (also referred to herein as the network, learning, and retraining module) is configured to support distributed learning and/or update the model (or detection and classification module 203) for specific nuisances, pests, concerns, and/or threats, and communicate learned effectiveness of regional deterrence and/or mitigation factors. In some embodiments, the network, learning, and retraining module 211 uses results from the detection and classification module 203 and the deterrence and mitigation module 206 to retrain either module (2103, 206). In such embodiments, there may be a feedback pathway (illustrated in FIG. 2 as arrows) between the network, learning, and retraining module 211 and the detection and classification module 203 and/or the deterrence and mitigation module 206. For example, if the deterrence and mitigation module 206 is successful in deterring or mitigating the maritime concern, the successful results may be transmitted to the network, learning, and retraining module 211, stored, and used later. The same deterrent or mitigation measure may be applied to the same maritime concern in the future.

FIG. 3 is an illustration of the method and system 300 showing a simplified block diagram and key subcomponents or algorithms for each of the functional blocks indicated in FIG. 2, in accordance with the present technology. FIG. 3, shows a novel hybrid framework that applies statistical processing and learning models in concert with local image feature processing to provide for dynamic motion stabilization of sensor output, background suppression/subtraction and scene change detection for generalized event and activity detection while enhancing performance of one or more AI/ML algorithms for detection and classification of concerns as previously noted. The dashed vertical line delineates the processor 3000 from components of the system 300 external to the processor 3000.

In some embodiments, system 300 includes a plurality of sensors 301 and a plurality of deterrents/mitigation factors 307A, 307B, 307C. In some embodiments, the system 300 further includes a processor 3000, including sensor inputs 302, a filter 312, a detection and classification module 303, a threshold detector 314, an envelope detector 315, a fusion logic module 313, and a deterrence and mitigation module 306.

In some embodiments, sensor inputs 302 from multiple sensors 301 may be used for cross-modal detection and fusion leading to increased performance and confidence. In some embodiments, the sensor inputs 302 are filtered with a filter 312, an audio or vibration filter 315. In some embodiments, the audio or vibration filter 315 may be an envelope detector. In some embodiments, the filter 312 increases the performance and/or confidence of the sensor inputs 302.

In some embodiments, the detection and classification module 303 includes a stabilization module 316, a scene change detector 317, a background suppressor 318, a first classifier 319A, and a second classifier 319B. The stabilization module 316 is configured to stabilize motion in image data from one or more image sensors (of the plurality of sensors 301). The stabilization module 316 may be further configured to subtract non-static background from the image data.

The scene change detector 317 is configured to detect a foreground of an image or video data and emphasize scene changes within the data. The foreground detector 317 may issue a scene change alert. If the scene change alert is confirmed by detection of a concern via the AI/ML algorithm(s), no adjustment to the threshold detector 314 is indicated, however, should the scene change detector 317 generate an alert when no concern is detected or classified by the AI/ML algorithm(s) then the threshold of the threshold detector 314 may be too low and may be increased accordingly. Conversely, if no scene change alert is indicated, but the AI/ML algorithm(s) detects a concern or indicates the presence of a particular class of concern, then the scene change threshold may be too high, resulting in a false negative alert. In such cases, the threshold may be adjusted lower.

The background suppressor 318 is configured to suppress the background of image data or audio data from the plurality of sensors 301. In some embodiments, one or more alerts A may be generated by the fusion of sensor inputs 302 at the fusion logic module 313 derived from scene change detector 317, audio or vibration input (envelope detection 315) and available AI/ML algorithm outputs. This alert A may be reported locally to the owner or crew on-board or nearby, reported via the network for remote notification and event archival, alarmed for attention depending on the nature of the concern, and/or used to activate an appropriately tailored deterrence method or subsequent mitigation method.

Accordingly, the fusion logic module 313 is configured to generate alerts and/or alarms based on the determinations by the detection and classification module 303. In some embodiments, the fusion logic module 313 is further configured to provide threshold/envelope/error feedback to adjust the threshold of the threshold detector 314 of the envelope detector 315.

In some embodiments, the system 300 includes a first classifier 319A and a second classifier 319B. In some embodiments, the first classifier 319A is a deep neural network (DNN). In some embodiments, the DNN or other classifier may confirm the presence of a concern in parallel, or in concert with, generation of a scene-change alert enabled by the scene change detector 317.

On another level, the first classifier 319A, or DNN, is optimized for classification of video content by recognizing features on a frame-by frame basis may be applied in parallel with the second classifier 319B.

In some embodiments, the second classifier 319A is an AI/ML algorithm such as a Long Short-term Memory (LSTM) network that has been trained to recognize temporal sequences such as movements (e.g., hovering, landing, circling, boarding, slithering, etc.). For certain concerns, or certain species, the respective outputs of these algorithms (i.e., the first classifier 319A and the second classifier 319B) may be fused with the fusion logic module 313 to increase confidence in determining the presence of a concern, or its more specific classification. Additionally, activity, behavior, or event indications from temporal segments or video may provide additional context for determining deterrence methods or mitigation measures.

Beyond general alerting from audio or vibration detection 315, the second classifier 319B (or LSTM) may be applied to recognize sound or song patterns from birds, other vocalizations from marine mammals, or human speech activity as an indicator of a class of concern.

Further, the fusion logic module 313 may be applied to compare classification results from the AI/ML networks (classification and detection module 303) trained on respective audio, image and or motion features to greatly increase confidence through weighted confidence scoring. For example, if the song of a particular bird species is recognized at a moderate level of confidence and simultaneous classification of the corresponding concern using image features returns a similarly moderate score with the same classification, then the combination of the two moderate scores may be fused to provide a combined confidence score that may exceed a relatively higher score from a single modality. In some embodiments, the first classifier 319A and/or the second classifier 319B communicate with the fusion logic module 313 to for validation and/or feedback.

In some embodiments, the fusion logic module 313 is configured to output an alert A (such as a scene change alert), and a classification C. In this manner, the fusion logic module 313 indicates a detection and a classification was made by the detection and classification module 303. In some embodiments, the alert A and the classification C are transmitted to the deterrence and mitigation module 306.

The deterrence and mitigation module 306 receives the alert A and the classification C. In some embodiments, the deterrence and mitigation module 306 further receives a command, approval, or denial instruction M from a monitor (such as monitor 205). In this way, a user or attendant of the system may approve, deny, adjust, or confirm the deterrent or mitigation factor 307A, 307B, 307C selected by the deterrence and mitigation module 306. The deterrence and mitigation module 306 then directs one or more deterrent or mitigation factor 307A, 307B, 307C to remedy or mitigate the maritime concern.

The system 300 may communicate with a network at multiple stages of the process. For example, the first classifier 319A may receive or transmit AI/ML model updates to or from the network at N1. Similarly, the second classifier 319B may receive or transmit AI/ML model updates to or from the network at N2. In some embodiments, the detection and mitigation module 306 may also communicate with the network at N3. In some embodiments, the filter 312 may also communicate with the network at N4, and the fusion logic module 313 may communicate with the network at N5. In each case, the communication may include a feedback pathway, where the network N1, N2, N3, N4, N5 may retrain the system 300 based on results, determinations, or outputs from each respective module (319A, 319B, 306, 312, 313). In some embodiments, the network N1, N2, N3, N4, N5 is the network, learning, and retraining module 211 of FIG. 2.

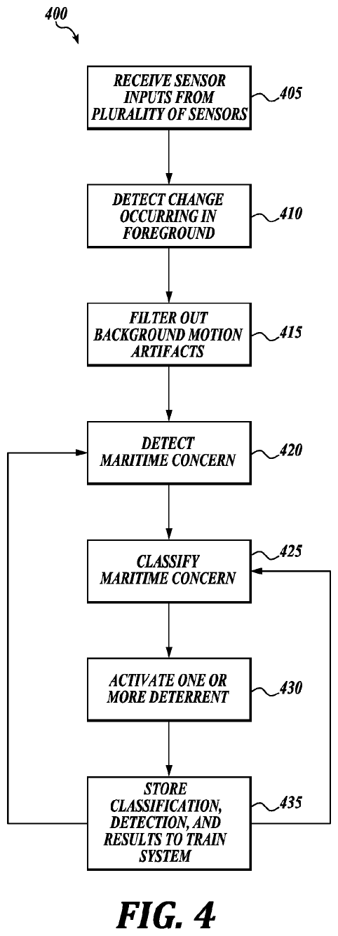

FIG. 4 is a method 400 of using the system, in accordance with the present technology. In some embodiments, the method 400 may be performed with the system 100, 200, or 300. It should be understood that method 200 should be interpreted as merely representative. In some embodiments, process blocks of method 400 may be performed simultaneously, sequentially, in a different order, or even omitted, without departing from the scope of this disclosure.

In block 405, sensor inputs (such as sensor inputs 202, 302) are received from a plurality of sensors (such as plurality of sensors 101A, 101B, 101C, 201, 301). The plurality of sensors may include any of the sensors disclosed herein. In some embodiments, each sensor of the plurality of sensors captures a different kind of data (such as audio, visual, tactile, or the like). In other embodiments, multiple sensors in the plurality of sensors may capture the same data.

In block 410, a change occurring in the foreground of the sensor inputs is detected. In some embodiments, the change occurring in the foreground is detected with a scene change detector (such as scene change detector 317).

In block 415, background motion artifacts are filtered out. In some embodiments, the is achieved with a filter (such as filter 312), a stabilization module (such as stabilization module 316), and/or a background suppressor (such as background suppressor 318).

In block 420, a maritime concern is detected. In some embodiments, the maritime concern may be a pest, such as a species of bird, a safety or security concern, such as a person going overboard, or a threat, such as an intruder. In some embodiments, the maritime concern in detected with a detection and classifier module (such as detection and classifier module 203, 303).

In block 425, the maritime concern is classified. In some embodiments, this is also done with the detection and classifier module. The maritime concern may be classified with one or more AI/ML algorithm, or classifier (such as first classifier 319A, and/or second classifier 319B). In some embodiments, the one or more classifiers may include a deep neural network (DNN) or a long short-term memory (LTSM) classifier.

In block 430, one or more deterrent (or mitigation factor) is activated. In some embodiments, the one or more deterrent may be activated based on the detection and classification of the maritime concern. In some embodiments, the one or more deterrents may be approved, denied, changed, or adjusted by a command from a user or attendant of the system.

In block 435, the classification, detection, and/or results of the one or more deterrent method are stored or otherwise shared with a network (such as network, learning, and retraining module 211 or network N1, N2, N3, N4, N5). In this way, the network may re-train the system and improve its detection, classification, and/or deterrent functions in the future. For example, if a deterrent was unsuccessful against a specific maritime concern, the network could direct the system to not employ this deterrent in the future. Similarly, if a classification was correct, the network could store this correct result and use it to inform additional classifications in the future.

While illustrative embodiments have been illustrated and described, it will be appreciated that various changes can be made therein without departing from the spirit and scope of the invention.

1. A system for detecting a maritime concern, the system comprising:
a plurality of sensors configured to collect sensor inputs;
one or more processors configured to detect a change occurring in a foreground over broader background change measurements in the sensor inputs;
a plurality of deterrent methods configured to deter the maritime concern; wherein the one or more computing devices are further configured to execute steps including:
filter out background motion artifacts associated with maritime environments;
detect a maritime concern based on the sensor data with the at least one detection algorithm;
classify the maritime concern based on the sensor data; and
activate at least one deterrent method of the plurality of deterrent methods to deter the maritime concern based on its classification.

2. The system of claim 1, wherein the plurality of deterrent methods comprises display warnings, lights, sounds, vibrations, release of repellants, actuated or robotic movements in various patterns or amplitudes, release of one or more drones, or a combination thereof.

3. The system of claim 1, wherein the one or more computing devices are further configured to:
after activating the at least one deterrent method, detect whether the maritime concern is eliminated, and, when the maritime concern is not eliminated,
store the at least one deterrent method with the classification of the maritime concerns as an unsuccessful deterrence;
escalate deterrence by activating at least a second deterrent method of the plurality of deterrent methods; and
when the maritime concern is eliminated,
store the at least one deterrent method with the classification of the maritime concern as a successful deterrence.

4. The system of claim 3, wherein the one or more computing devices are further configured to:
store the successful deterrence or the unsuccessful deterrence with corresponding metadata comprising time, date, location, environmental conditions, or a combination thereof along with sensed data from the plurality of sensors; and
when another maritime concern having the same classification as the successful deterrence is detected,
activate the at least one deterrence of the successful deterrence, and
when the another maritime concern having the same classification as the unsuccessful deterrence is detected,
activate another deterrence of the plurality of deterrence that is distinct from the at least one deterrence of the unsuccessful deterrence.

5. The system of claim 4, wherein the one or more computing devices are further configured to:
share the successful deterrence or the unsuccessful deterrence with a community network to improve performance of the system.

6. The system of claim 3, wherein the system further comprises:
a plurality of mitigation measures configured to remedy the maritime concern, wherein the one or more computing devices are further configured to:
detect whether the maritime concern is eliminated by the at least second deterrent method, and when the maritime concern has not been eliminated,
activate at least one mitigation measure of the plurality of mitigation measures based on the classification of the maritime concern.

7. The system of claim 1, wherein classification of the maritime concern comprises a species of the maritime concern.

8. The system of claim 1, wherein the plurality of sensors is selected from visible wavelength cameras or video sensors, near-Infrared (NIR) cameras or video sensors, thermal cameras or video sensors, acoustic sensors, inertial sensors, accelerometers, light detection and ranging (LIDAR) sensors, sound navigation and ranging (SONAR) sensors, sensors from an autonomous/semi-autonomous vehicle, and combinations thereof.

9. The system of claim 1, wherein classification of the maritime concern comprises implementing at least an artificial intelligence (AI) algorithm, a machine learning (ML) algorithm, or a combination thereof.

10. The system of claim 1, wherein the maritime concern is a safety concern or a security concern, wherein the one or more deterrent methods is one or more mitigation measures, and wherein the one or more mitigation measures include activation of a motion tracking camera system, deployment of an airborne or surface drone, a station keeping buoy, a floating marker, a life preserver, a flotation device, an alert, or a combination thereof.

11. A method of detecting a maritime concern, the method comprising:
filtering out background motion artifacts associated with maritime environments;
detecting a maritime concern based on the sensed data with at least one detection algorithm;
classifying the maritime concern based on the sensor data; and
activating at least one deterrent method of a plurality of deterrent methods to deter the maritime concern based on its classification.

12. The method of claim 11, further comprising:
after activating the at least one deterrent method, detecting whether the maritime concern is eliminated, and, when the maritime concern is not eliminated,
storing the at least one deterrent method with the classification of the maritime concerns as an unsuccessful deterrence;
escalating deterrence by activating at least a second deterrent method of the plurality of deterrent methods; and
when the maritime concern is eliminated,
storing the at least one deterrent method with the classification of the maritime concern as a successful deterrence.

13. The method of claim 12, further comprising:
storing the successful deterrence or the unsuccessful deterrence with corresponding metadata comprising time, date, location, environmental conditions, or a combination thereof along with sensed data from the plurality of sensors; and
when another maritime concern having the same classification as the successful deterrence is detected,
activating the at least one deterrence of the successful deterrence, and
when the another maritime concern having the same classification as the unsuccessful deterrence is detected,
activating another deterrence of the plurality of deterrence that is distinct from the at least one deterrence of the unsuccessful deterrence.

14. The method of claim 13, further comprising sharing the successful deterrence or the unsuccessful deterrence with a community network to improve performance of the system.

15. The method of claim 13, further comprising:
detecting whether the maritime concern is eliminated by the at least second deterrent method, and when the maritime concern has not been eliminated,
activating at least one mitigation measure of a plurality of mitigation measures based on the classification of the maritime concern.

16. The method of claim 11, wherein classification of the maritime concern comprises a species of the maritime concern.

17. The method of claim 11, wherein the plurality of sensors is selected from cameras, video sensors, acoustic sensors, light detection and ranging (LIDAR) sensors, sound navigation and ranging (SONAR) sensors, near infrared sensors, thermal sensors, sensors from an autonomous/semi-autonomous vehicle, and combinations thereof.

18. The method of claim 11, wherein classification of the maritime concern comprises implementing at least an artificial intelligence (AI) algorithm, a machine learning (ML) algorithm, or a combination thereof.

19. The method of claim 11, wherein the maritime concern is a safety concern or a security concern, and wherein the one or more deterrent methods include deployment of a drone, a life preserver, a flotation device, an alert, or a combination thereof.

20. The method of claim 11, wherein the plurality of deterrent methods comprise lights, sounds, vibrations, release of repellants, release of one or more drones, actuated or robotic movements in various patterns or amplitudes, or a combination thereof.
